(19) United States
(12) Patent Application Publication
(10) Pub. No.: US 2011/0000302 A1
(43) Pub. Date: Jan. 6, 2011

(54) Method for ultrasonic inspecting a substantially circumferential weld and an apparatus for carrying out such method

(76) Inventors: Xavier Georges Jose Deleye, Rotterdam (NL); Frederik Hendrik Dijkstra, Oudenbosch (NL); Khalid Chougrani, Rotterdam (NL); Adrianus Maria Cornelius Van Den Biggelaar, Lekkerkerk (NL); Hubertus Rundberg, Krimpen a/d IJssel (NL)

Correspondence Address: JACOBSON HOLMAN PLLC, 400 SEVENTH STREET N.W., SUITE 600, WASHINGTON, DC, 20004, US

(21) Appl. No.: 12/458,161

(22) Filed: Jul. 1, 2009

(51) Int. Cl. G01N 29/04

(52) U.S. Cl. 73/637

(57) ABSTRACT

A method for ultrasonic inspecting a substantially circular circumferential weld which connects an inner pipe and an outer pipe which are aligned coaxial relative to each other, the method comprising the steps of:
a) positioning at least one ultrasonic probe inside the inner pipe;
b) moving the at least one probe in tangential direction relative to the inner pipe a while emitting at least one ultrasonic beam towards the weld and receiving ultrasonic signals by means of the at least one probe.

The invention relates to a method for ultrasonic inspecting a substantially circumferential weld which connects an inner pipe and an outer pipe which are aligned co-axially relatively to each other. The invention also relates to an apparatus for carrying out such method.

Such a method and apparatus are known from US 2009/0078742 A1.

According to the known method at least one ultrasonic probe is positioned inside the inner pipe such that, in use, it lies against the inside surface of the inside wall of said inner pipe. The at least one probe is a phased array probe. The phased array probe which is positioned in the inner pipe emits an ultrasonic beam to scan the weld. During said scan, the probe is positioned in a given position and therefore stands still in this position. After scanning the weld at that particular position, the probe is moved in a circumferential direction of the inner pipe, preferably the probe is rotated around about an axis of said pipe through a given angle less than one degree. After the probe has been rotated and stands still again relative to the pipe, a scanning beam is transmitted again by said probe to scan while the probe is positioned in said new given position. The above referred to steps are repeated until the entire circumference of said weld has been inspected.

A disadvantage of this known method is that the inspection of the circumferential weld may take a relatively long time. The known apparatus is arranged for carrying out such known method. The apparatus is provided with a shaft which, in use, extends along an axial axis of the inner pipe. The apparatus is further provided with connecting means for connecting the shaft with the inner and/or outer pipe. The at least one probe is attached to the shaft. The apparatus is further provided with motor drive means for moving the probe in translation along the axial direction of the inner pipe and for stepwise rotating the at least one probe about the axial axis of the inner pipe. A disadvantage of the known apparatus is that it may become relatively expensive and that the at least one probe is not able to follow the contour of the inner pipe in case the inner pipe turns out to have not a perfectly circular cross section. Another disadvantage of the known method/apparatus is that not all areas of the weld are covered sufficiently with the probe(s) only on the inside.

The invention provides a method and an apparatus for providing a solution for at least one of the above referred to draw backs.

According to the invention, the method comprises the steps of

a) positioning at least one ultrasonic probe inside the inner pipe; b) moving the at least one probe in tangential direction relative to the inner pipe while emitting at least one ultrasonic beam towards the weld and receiving ultrasonic signals by means of the at least one probe. Because the at least one probe is moved in tangential direction while emitting at least one ultrasonic beam, scanning the weld along a complete circumferential path along the weld can be carried out relatively quickly because it is not required to stop the movement of the at least one probe during emitting the at least one ultrasonic beam by means of the ultrasonic probe. Hence, inspection of the entire weld can be carried out relatively quickly because the movement of the at least one probe in the tangential direction does not need to stop.

Preferably it holds that the at least one probe is a phased array probe and wherein by means of the phased array probe at least one scanning ultrasonic beam is generated wherein the direction and/or position of the scanning ultrasonic beam varies relative to the at least one probe while the at least one probe moves in the tangential direction and wherein the scanning by means of the ultrasonic beam comprises varying the direction and/or position of the beam relative to the at least one probe. Preferably the scanning of the ultrasonic beam comprises varying the direction and/or position of the beam relative to the at least one probe while the beam remains in a plane which comprises an axial axis of the inner pipe. Said scanning by means of the ultrasonic beam also comprises the movement of the at least one ultrasonic probe in the tangential direction of the inner pipe. Hence, inspection of the entire weld can be carried out relatively quickly without stopping the movement of the at least one probe.

Preferably the position of the at least one probe in axial direction relative to the inner pipe is set manually. Also preferably the position of the at least one probe in radial direction relative to the inner pipe is set manually and preferably the contact of the probe to the pipe surface is ensured by a spring load. The movement of the at least one probe in tangential direction of the inner pipe is carried out preferably by means of a motor drive means. Preferably by means of the at least one probe the entire width of the weld in axial direction of the inner pipe is scanned. According to a special embodiment in step a) at least a first phased array probe, a second phased array probe and a third phased array probe are positioned inside the inner pipe wherein the second probe faces the weld at least substantially in the middle of the weld viewed in axial direction of the inner pipe and wherein the first probe is staggered relative to the second probe in a first axial direction of the inner pipe, the third probe is staggered relative the second probe in a second axial direction of the inner pipe and wherein the first and second axial direction are opposed axial directions and wherein in step b) each of the probes are moved in tangential direction relative to the inner pipe along the weld while each of the probes emitting at least one ultrasonic beam and receiving ultrasonic signals by means of the probes. By such a preferred method it is possible to scan the complete width of the weld as viewed in an axial direction of the inner pipe by means of the first, second and third phased array probe.

According to a preferred method in step a) at least one outer phased array probe is positioned outside the outer pipe and outside the inner pipe and faces the outer pipe wherein in step b) the at least one outer probe is also moved in tangential direction relative to the inner pipe while emitting at least one ultrasonic beam towards the weld and receiving ultrasonic signals by means of the at least one outer probe. Due to the use of the at least one outer phased array probe it is possible to more accurately detect and optimally size possible defects anywhere in the weld.

The apparatus according to the invention is characterized in that said apparatus comprises a circumferential guide rail which is arranged to be mounted around an outer wall of the inner pipe and/or around an outer wall of the outer pipe, a carrier which is attached to the guide rail for travelling, in use, along the guide rail around the inner pipe and/or the outer pipe, an arm attached to the carrier and which is arranged, in use, to extend from the carrier via an open end of the inner pipe into the inner pipe, at least one ultrasonic probe attached to the arm so that, in use the at least one ultrasonic probe is present inside in the inner pipe and motor drive means for moving the carrier along the guide rail for carrying out any step b) as discussed above. By means of such an apparatus the method can be carried out in a relatively simple manner. The circumferential guide rail can be attached around the inner pipe or around the outer pipe in a known manner. The guide rail may be made to have a shape corresponding to the shape of the inner pipe and/or the outer pipe. This has the advantage that if the carrier is moved along the guide rail, the carrier and thereby the at least one ultrasonic probe will follow the specific shape of the inner pipe if the circumferential guide rail follows the shape of the inner pipe. For example, if the inner pipe doesn't have a perfectly circular cross section, with for example a slightly oval cross section, the circumferential guide rail may have the same oval shape. Preferably the arm comprises a L-shaped portion wherein a first leg of the L-shaped portion extends in a radial direction of the circumferential guide rail and wherein a second leg of the L-shaped portion extends at least substantially perpendicular to a plane comprising the circumferential guide rail and wherein the at least one probe is attached to the second leg. Preferably the second leg is off-set relative to a line which is at least substantially perpendicular to a plane wherein the guide rail lays and which line extends to a centre point of a circle along which the guide rail at least substantially extends. This means that, in use, the second leg will be off-set relative to the axial axis of the inner pipe. It also means that the first leg may be relatively short relative to a radius of the guide rail. Preferably the apparatus is arranged for varying and setting the position of the at least one probe relative to the carrier and/or for varying and setting the position of the at least one probe relative to the carrier wherein said position can be varied in a direction extending at least substantially perpendicular to a plane comprising the circumferential guide rail and in a radial direction relative to the circumferential guide rail. Preferably the apparatus is arranged for varying and setting the position of the at least one probe relative to the carrier manually. This may make the apparatus relatively cheap.

The invention will now be further discussed with reference to the drawings.

In the drawings:

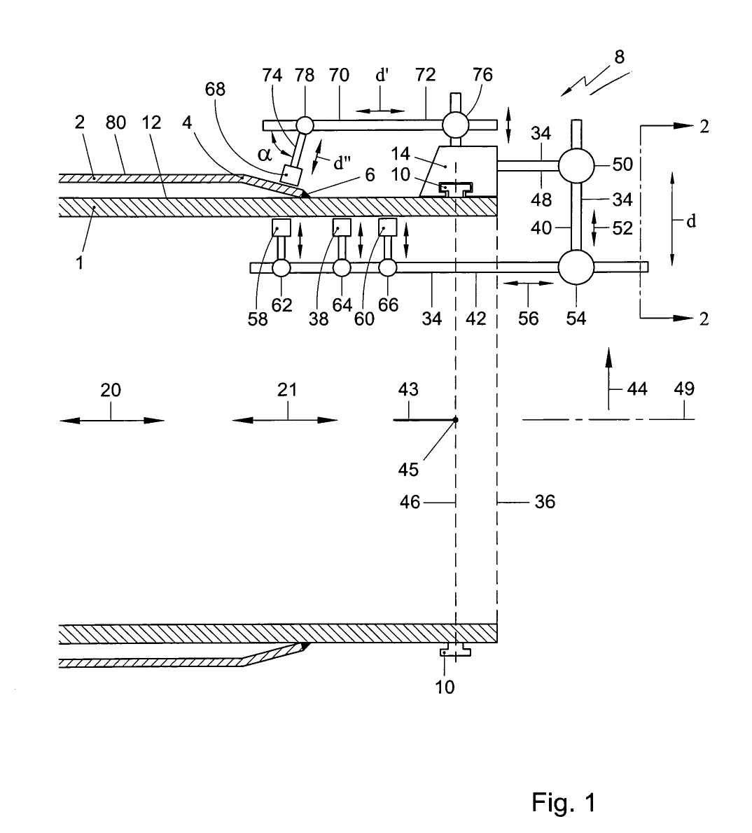

FIG. 1 shows a cross section of an inner pipe and an outer pipe which are welded together and an ultrasonic inspection apparatus according to an embodiment of the invention for carrying out a method according to the invention;

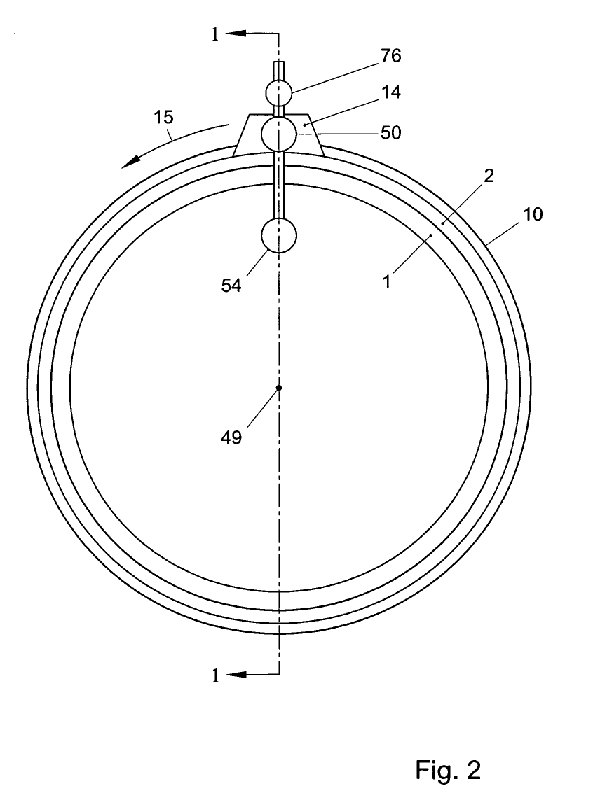

FIG. 2 a cross section of the inner pipe, outer pipe and apparatus according to FIG. 1;

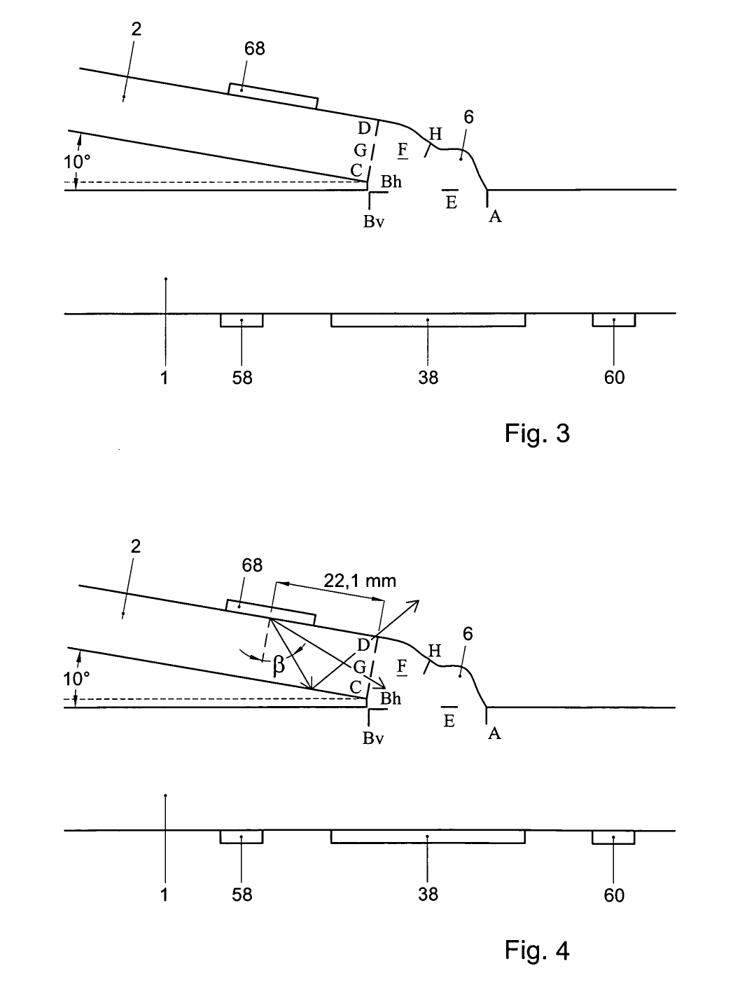

FIG. 3 a possible position of phased array probes of the apparatus of FIG. 1;

FIG. 4 possible ultrasonic beams generated by phased array probe 68 of the apparatus according to FIG. 1;

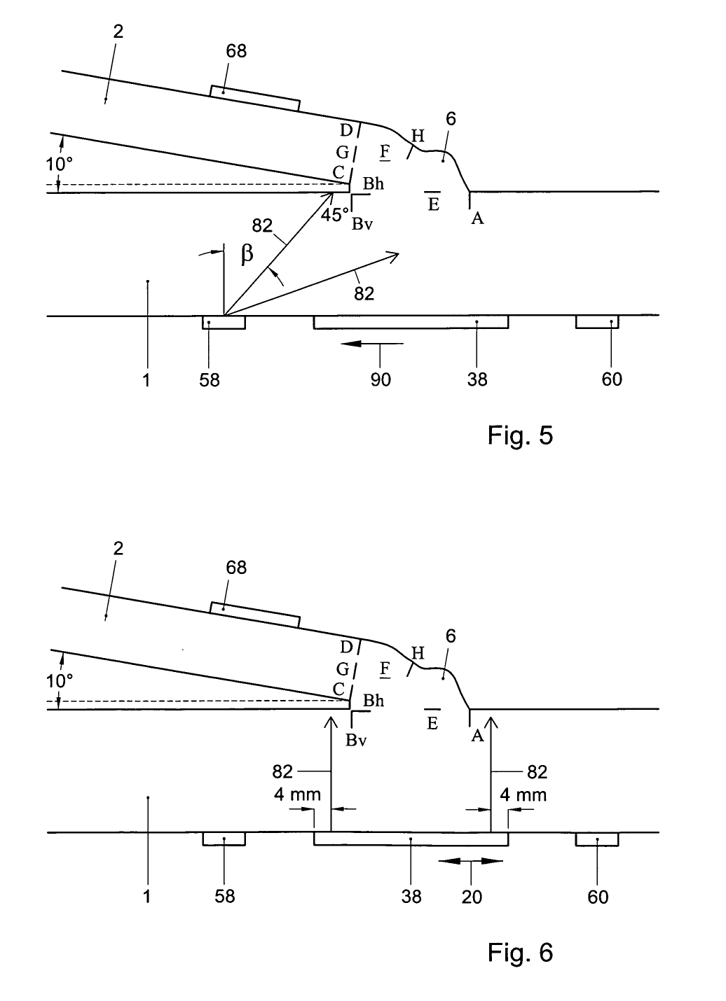

FIG. 5 possible ultrasonic beams generated by phased array probe 58 of the apparatus according to FIG. 1;

FIG. 6 possible ultrasonic beams generated by phased array probe 38 of the apparatus according to FIG. 1;

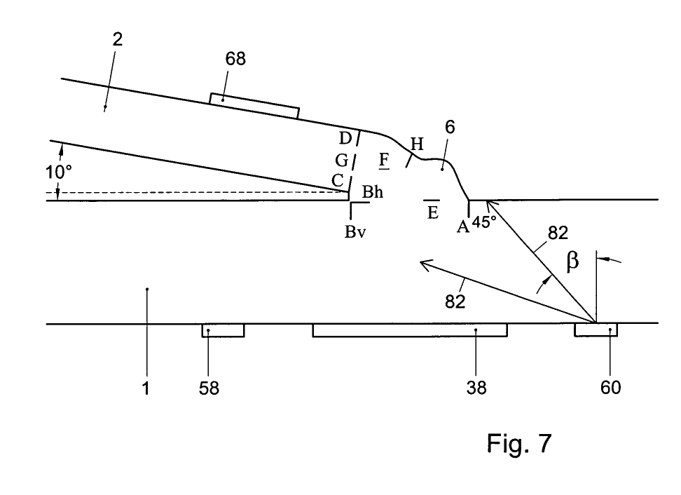

FIG. 7 possible ultrasonic beams generated by phased array probe 60 of the apparatus according to FIG. 1.

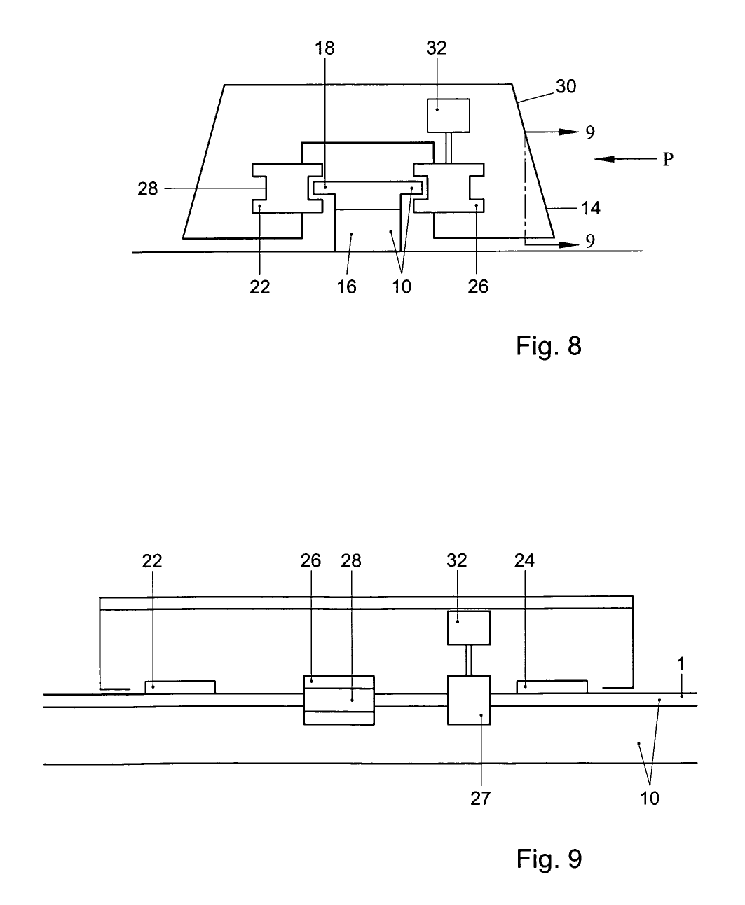

FIG. 8 shows in detail the carrier 14 and the guide rail of the apparatus shown in FIG. 1;

FIG. 9 shows a view in a direction of the arrow P of FIG. 8; and

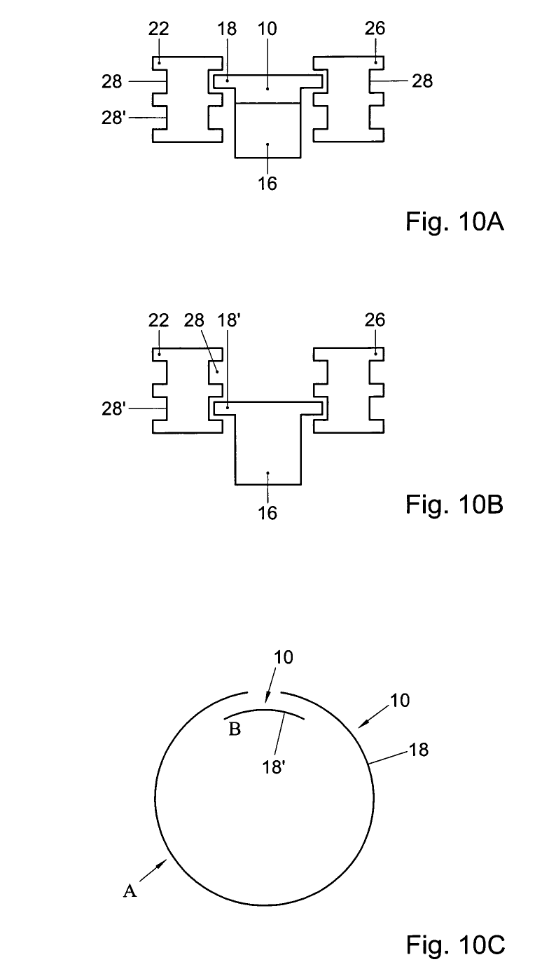

FIG. 10 shows in more detail a special embodiment of the guide rails and guide wheels as shown in FIGS. 8 and 9.

In FIG. 1 an inner pipe 1 has reference number 1. Furthermore an outer pipe 2 is provided and which is crooked at a position 4 wherein the inner and the outer pipe are welded together by means of a weld 6. In FIG. 1 an apparatus 8 is shown comprising a circumferential guide rail 10 which is mounted around an outer wall 12 of the inner pipe 1. The apparatus is further provided with a carrier 14 which is attached to the guide rail 10 for travelling, in use, along the guide rail around the inner pipe 1 in a travelling direction 15. As shown in more detail in FIGS. 8 and 9 in this example the guide rail is provided with a relatively narrow base portion 16 and a larger upper portion 18. As viewed in an axial direction 20 of the inner pipe, the top portion 18 is wider than the base portion 16. The carrier is in this example provided with two guide wheels 22, 24 which are located in FIG. 8 on the left-hand side of the guide rail 10 and one guide wheel 26 which is located in FIG. 8 on a right-hand side of the guide rail 10. The guide wheels 22, 24 are separated in the travelling direction 15 relative to each other. The guide wheel 26 lies, as viewed in the travelling direction 15, between the guide wheels 22, 24. Each of the guide wheels is provided with a first slit 28 wherein a portion of the top portion of the guide rail extends. FIG. 9 shows the position of the guide wheels 22, 24, 26 as viewed in a direction of the arrow P in FIG. 8 wherein a side wall 30 of a housing of the carrier is omitted for clarity reasons. To enable a full circumferential movement of the carrier around the guide rail, the guide rail is provided, in its rail portion B (see FIG. 10c), with second extending portions 18′ which on both free ends of the extending portions 18′ overlaps with the extending portions 18. The extending portions 18 fails to be present around the middle of the rail portion B. In that embodiment the guide wheels 22, 24, 26 are each provided with a second slit 28′. In case the guide rails 22, 24, 26 are present at rail portion A of the guide rail the first extended portions 18 extend into the first slit 28 of the guide wheels (see FIG. 10a). In case the guide wheels are present at rail portion B the second extending portions 18′ will extend in the second slit 28′ of the guide wheels and depending on the position of the guide wheels at rail portion B, the first extending portions 18 may in addition extend in the first slits 28 (on those position where the first extending portions 18 and the second extending portions 18′ both are present).

The apparatus is provided with motor drive means 32 for driving a motor wheel 27 for transporting the carrier 14 for travelling in the travel direction 15. The motor wheel does not need to have a slit, but needs to have a rough surface to provide friction and to prevent slipping.

The apparatus (see FIG. 1) is further provided with an arm 34 attached to the carrier 14 and which is arranged, in use, to extend from the carrier 14 via an open end 36 of the inner pipe into the inner pipe. At least one ultrasonic probe 38 is attached to the arm so that, in use, the at least one ultrasonic probe is present inside the inner pipe.

In this example the arm 34 comprises an L-shaped portion 40, 42 wherein a first leg 40 of the L-shaped portion extends in a radial direction 44 of the circumferential guide rail 10. In this example the radial direction of the circumferential guide rail falls together with the radial direction 44 of the inner pipe. Furthermore, the L-shaped portion comprises a second leg 42 which extends at least substantially perpendicular to a plain 46 comprising the circumferential guide rail 10. The at least one probe 38 is attached to the second leg 42.

In this example, the arm 34 further comprises a third leg 48 for connecting the L-shaped portion 40, 42 to the carrier 14. In this example, the arm 34 is provided with a first coupling means 50 allowing to vary the distance between the second leg 42 and the third leg 48 in a direction 52. Furthermore, the arm is provided with a second coupling means allowing to re-position the second leg 42 relative to the third leg 48 in a direction 56. The distance d between the third leg 48 and the second leg 42 can be adjusted manually. Similarly, the position of the first leg 40 relative to the third leg 48 in a direction 56 can be adjusted manually.

Hence, it follows that the apparatus is arranged for varying the setting and the position of the at least one probe relative to the carrier. More specifically, the apparatus is arranged for varying and setting the position of the at least one probe relative to the carrier wherein said position can be varied in a direction 20 extending at least substantially perpendicular to a plain 46 comprising the circumferential guide rail 10 and in a radial direction 44 relative to the circumferential guide rail. The second leg 42 is off-set relative to a line 43 which is perpendicular to the plane 46 wherein the guide rail 10 lays and which line extends to a centre point 45 of a circle along which the guide rail at least substantially extends. This means that, in use, the second leg will be off-set relative to the axial axis 49 of the inner pipe. It also means that the first leg may be relatively short relative to a radius of the loop formed by the guide rail.

In this example, the probe 38 is a phased array probe. In this example, the apparatus is in addition to the probe 38, which probe 38 will be referred to as the second phased array probe, provided with a first phased array probe 58 and a third phased array probe 60. Each of the first phased array probe, second phased array probe and third phased array probe 58, 38, 60 are connected with the carrier. More specifically, each of these probes are connected to the arm 34. More specifically they are connected to the second leg 42 of the arm 34. As can be seen from FIG. 1, the first probe 58 is staggered relative to the second probe 38 in the direction 21 extending at least substantially perpendicular to a plain 46 comprising the circumferential guide rail 10. Also the third probe is staggered relatively the second probe in this direction 21. Viewed in the direction 20, the second probe 38 lies between the first probe 58 and the third probe 60. The arm is provided with third coupling means 62 for varying the position of the first probe 38 relative to the carrier 14 in the radial direction 44 and/or direction 21. Similarly the arm 34 is provided with four coupling means for varying the distance between the probe 38 and the carrier 14 in the direction 21 and/or radial direction 44. Also fifth coupling means 66 are provided for varying the distance between the third probe 60 and the carrier 14 in a direction 21 and/or radial direction 44. Hence, the position of the first probe, the second probe and the third probe can be adjusted relative to each other in the direction 21 and/or radial direction 44. This can be seen as a fine tuning of the probes relative to each other. The average distance of the probe relative to the carrier 14 can be adjusted manually by means of the first coupling means 50. Also the third coupling means 62, fourth coupling means 64 and the fifth coupling means 66 can be operated manually. To provide adequate contact with the pipe surface the probes may be individually spring loaded.

The apparatus is further provided with at least one outer phased array probe 68 which is connected with the carrier 14 and wherein the apparatus is arranged to position the outer phased array probe outside the outer pipe and outside the inner pipe. The outer phased array probe is attached to the carrier 14 by means of a second arm 70 comprising a first leg 72 and a second leg 74. The second arm 70 is provided with coupling means 76 for manually varying the position of the first leg 72 in the direction 20 and thereby varying the distance d′ between the carrier and the probe 68. The second arm 70 is further provided with second coupling means 78 for manually varying the distance d″ between the probe 68 and the first leg 72. Also the angle α between the first leg 72 and the second leg 74 can be varied so as to be able to position the outer probe flat against the outer wall 80 of the outer pipe at a position where the outer wall tapers.

In order to inspect the weld 6, the circumferential guide rail is mounted in a well-known manner around, in this example, the outer pipe as shown in FIG. 1. The carrier 14 is attached to the guide rail as also shown in FIG. 1. Subsequently the first probe, second probe, third probe and outer probe are positioned relative to each other and relative to the inner and outer pipe as shown in FIG. 1 by means of manually operating the coupling means 50, 54, 62, 64, 66, 76, 78. The positioning of the probes will be referred to as method step a). In this example each of the probes lay flat against a wall of the inner or outer pipe. Subsequently, the probes are moved in tangential direction (travelling direction) 15 relative to the inner pipe while emitting ultrasonic beams by means of the probes towards the weld and receiving ultrasonic signals by means of the probes. This is referred to as a method step b). The ultrasonic signals which are transmitted and received in the method step b) are subsequently analyzed in a method step c) for detecting and optionally sizing possible defects in the weld.

In this example, each of the probes is a phased array probe. By means of each phased array probe, at least one scanning ultrasonic beam is generated while these probes move in the tangential direction 15. Scanning by means of the ultrasonic beams generated by the ultrasonic probes respectively, comprises varying the direction and/or position of the beam relative to the probe which generates the ultrasonic beam. FIG. 3 shows in more detail the position of the probes 58, 38, 60, 68 relative to the inner pipe 1, the outer pipe 2, and the weld 6. In FIG. 3 possible defects in the weld are referred to with A, Bv, Bh, C, D, E, F, G, H. In use, by means of the outer probe 68, ultrasonic beams are radiated wherein the angle β varies from 40 until 70 degrees, see FIG. 4. This is a so-called sectorial scan. The phased array probe 68 has in this example, a total size of 17.62 mm., a pitch of 0.43 mm and comprises 41 transmitting phased array elements. In table 1 the specifications of each of the probes is provided for a specific situation and wall thickness.

TABLE 1

| | Total | Pitch | # | |
|---|---|---|---|---|
| Probe | size (mm) | (mm) | elements | Scan Technique |
| 68 | 17.62 | 0.43 | 41 | Sectorial scan |
| | | | | (40°-70°) |
| 58 | 8.17 | 0.43 | 19 | Sectorial scan |
| | | | | (40°-58°) |
| 38 | 37.73 | 0.77 | 49 | Linear scan |
| | active: 8.46 | (longi- | | (4 mm from edge) |
| | | tudinal) | | |
| 60 | 8.17 | 0.43 | 19 | Sectorial scan |
| | | | | (40°-58°) |

By means of the phased array probe 68, defects C, G and D can be detected and sized. In table 2 it is indicated which defect can be detected and/or sized by which probe(s).

TABLE 2

| Defect | 68 | 58 | 38 | 60 |
|---|---|---|---|---|
| A | | | | X |
| Bh | | | X | |
| Bv | | X | | |
| C | X | | | |
| D | X | | | |
| E | | | X | |
| F | | | X | |
| G | X | | | |
| H | X | | X | |

As shown in FIG. 5, the ultrasonic beams which are generated by means of probe 58 do have an angle β varying between 40 and 58 degrees relative to a normal of a surface of the probe. The scan is a sectorial β wherein β varies between a value of 40 and 58 degrees. By means of the probe 58, defects Bv can be detected and possibly sized.

By means of phased array probe 38 a linear scan can be carried out wherein the origin of the ultrasonic beam 82 is varied in the direction 20 (FIG. 6). The center of the outer most left-hand beam has a distance of 4 mm from the edge of the probe 38 wherein the center of the outer most right-hand beam also has a distance of 4 mm to the right-hand edge of the probe 38. By means of probe 38, defects Bh, E, F and H can be detected and possibly sized This is shown in FIG. 6.

Finally as shown in FIG. 7, by means of the probe 60, a sectorial scan is carried out wherein the direction of the beam varies such that the angle β varies between 40 and 58 degrees. By means of probe 60, defect A can be detected and possibly sized.

Hence, by means of each of the probes a scanning is carried out as discussed for FIGS. 3-7. However, because at the same time the carrier is moved in a travelling direction 15, the scanning of each of the beams also include the movement of the ultrasonic probes in the tangential direction 15 of the inner pipe. Each of the ultrasonic probes face the weld in the moving and scanning step b). The scanning movement of the beams relative to the probes on the one hand, the velocity of the probes in the direction 15 on the other hand, as well as the width of each of the beams is dimensioned such that the complete weld is inspected if the carrier is transported along a complete circumference of the guide rail. More specifically, it holds for each probe that the scanning movement of the beams which are generated by such probe, the width of the beams which are generated by such probe and the speed wherein the carrier is moved in the direction 15, are adjusted to each other such that said beams, in combination, cover a portion of the weld which forms a closed loop. For example, beams 82 which are generated by the probe 58 overlap each other in the area of interest, in this case the weld, for different values of the angle β but do also overlap each other in the area of interest for different positions of the carrier 14. The same applies for the beams which are generated by the probes 60 and 68. Also the beams which are generated by the probe 38 overlap each other for mutually different originating positions from the probe 38. However, the beams 82 which are generated by means of the probe 38 also overlap each other for different positions of the carrier 14 in the direction 15.

Hence, it holds for each probe that by means of each probe, scanning beams are generated wherein beams which are distanced relative to each other in the tangential direction 15 of the pipe are adjacent or overlap and wherein beams which are distanced relative to each other in the scanning direction of the probe, are adjacent or overlap. Hence, it holds for each probe that by means of the at least one probe, scanning beams are generated wherein beams which are distanced relative to each other in the tangential direction 15 of the pipe, are adjacent to each other or overlap and wherein beams which are distanced relative to each other in the scanning direction of the at least one probe are adjacent to each other or overlap. In other words for each of the probes it holds that at least one scanning beam is generated which on the weld described a scanning path wherein portions of the path which are distanced relative to each other in the tangential direction of the pipe are adjacent to each other or partially overlap so that a circumferential portion of the weld in the form of a closed loop is scanned by the at least one scanning beam and wherein the circumferential portions of the weld in the form of a closed loop belonging to the probes in combination cover the full weld. The frequency of the ultrasonic beams is in this example about 7.5 MHZ. For the sectorial scans (FIGS. 4, 5, 7) shear waves may be used. For the linear scan (FIG. 6) a longitudinal wave may be used.

The invention is not limited to the above referred to embodiments. For example, the first probe 58 may be omitted. In such an embodiment by means of the probes 38, 60 and 68, a scan is performed as discussed above. Hence, it holds that the full circumferential portion of the weld is inspected. In this case the complete weld is inspected, however because of the lack of probe 58, a defect Bv may not be detected. Therefore, after a complete circumferential scan has been carried out, the probes 38 and 60 are manually moved in the axial direction referred to as 90 in FIG. 5, corresponding to the axial direction of the inner pipe and the normal of a plain wherein the guide rail lies, so that the probe 60 takes the position of the probe 58 which is omitted. The displacement of the probes 38 and 60 can be carried out by operating the coupling means 54 for varying the position of the second leg in the direction 76 (which is the same direction as direction 90 in FIG. 5). After that the probe 60 takes position of the omitted probe 58, a new circumferential scan can be carried out wherein the beams 82 are varied as discussed in relation with probe 58 in FIG. 5. By means of these beams, defects Bv can be detected and possibly sized.

Furthermore, in this example the guide rail is attached and fixed around the inner pipe 2. It is however also possible that the guide rail is attached to the outer pipe 2. In such case the third leg 58 should be longer so that it is possible that the arm 34 extends from the carrier 34 into the inner pipe via the opening 36. Such variants all fall within the scope of the invention as defined by the attached claims.

Other variants are also possible. For example, with reference to FIG. 3, a TOFD technique (Time Of Flight Diffraction) can be used on the inner pipe 1 to provide complimentary defect information (detection and sizing). Two pairs of TOFD probes which can be formed by the phased array probe 58 and the phased array probe 60 respectively, directed at A and Bv may for example be considered. Alternatively additional TOFD probes can be positioned substantially at the position of phased array probe 58 and the phased array probe 60. In case that the defect F is not parallel to the inner pipe, it can be detected and sized using sectorial scans with probes 58, 38, and 60. Defect G can for example be detected and sized using a PA-tandem technique with probe 58. Defect D can for example be detected using Creepwave technique with probe 68. Such variants all fall within the scope of the present invention.

1. A method for ultrasonic inspecting a substantially circular circumferential weld which connects an inner pipe and an outer pipe which are aligned coaxial relative to each other, the method comprising the steps of:
a) positioning at least one ultrasonic probe inside the inner pipe;
b) moving the at least one probe in tangential direction relative to the inner pipe while emitting at least one ultrasonic beam towards the weld and receiving ultrasonic signals by means of the at least one probe.

2. The method according to claim 1 wherein the ultrasonic signals which are received in step b) are analysed in a step c) for detecting and optionally sizing possible defects in the weld.

3. The method according to claim 1 wherein the at least one probe is a phased array probe and wherein by means of the phased array probe at least one scanning ultrasonic beam is generated wherein the direction and/or position of the scanning ultrasonic beam varies relative to the at least one probe while the at least one probe moves in the tangential direction and wherein the scanning by means of the ultrasonic beam comprises varying the direction and/or position of the beam relative to the at least one probe.

4. The method according to claim 3 wherein the scanning of the ultrasonic beam comprises varying the direction and/or position of the beam relative to the at least one probe while preferably the beam remains in a plane which comprises and axial axes of the inner pipe.

5. The method according to claim 3 wherein the scanning by means of the ultrasonic beam also results from the movement of the at least one ultrasonic probe in the tangential direction of the inner pipe.

6. The method according to claim 1 wherein the at least one ultrasonic probe faces the weld in step b).

7. The method according to claim 1 wherein in step a) the position of the at least one probe in the axial direction relative to the inner pipe is set manually.

8. The method according to claim 1 wherein in step a) the position of the at least one probe in a radial direction relative to the inner pipe is set manually.

9. The method according to claim 1 wherein the movement of the at least one probe in tangential direction of the inner pipe in step b) is carried out by means of a motor drive means.

10. The method according to claim 4 wherein by means of the at least one probe at least one scanning beam is generated which on the weld described a scanning path wherein portions of the path which are distanced relative to each other in the tangential direction of the pipe are adjacent to each other or partially overlap so that a circumferential portion of the weld in the form of a closed loop is scanned by the at least one scanning beam.

11. The method according to claim 1 wherein in step a) at least a first phased array probe, a second phased array probe and a third phased array probe are positioned inside the inner pipe wherein the second probe faces the weld at least substantially in the middle of the weld viewed in axial direction of the inner pipe and wherein the first probe is staggered relative to the second probe in an axial direction of the inner pipe, the third probe is staggered relative the second probe in the axial direction of the inner pipe and wherein viewed in the axial direction of the inner pipe the second probe lays between the first probe and the second probe and wherein in step b) each of the probes are moved in tangential direction relative to the inner pipe along the weld while each of the probes emits at least one ultrasonic beam and while receiving ultrasonic signals by means of the probes.

12. The method according to claim 11 wherein by means of the probes in combination the entire length of the weld in axial direction of the inner pipe is scanned.

13. The method according to claim 11 wherein for each of the probes it holds that at least one scanning beam is generated which on the weld described a scanning path wherein portions of the path which are distanced relative to each other in the tangential direction of the pipe are adjacent to each other or partially overlap so that a circumferential portion of the weld in the form of a closed loop is scanned by the at least one scanning beam and wherein the circumferential portions of the weld in the form of a closed loop belonging to the probes in combination cover the full weld.

14. The method according to claim 1 wherein in step a) at least one outer phased array probe is positioned outside the outer pipe and outside the inner pipe and faces the outer pipe wherein in step b) the at least one outer probe is also moved in tangential direction relative to the inner pipe while emitting at least one ultrasonic beam towards the weld and receiving ultrasonic signals by means of the at least one outer probe.

15. The method according to claim 11 wherein by means of each of the phased array probes at least one scanning ultrasonic beam is generated while the probes move in the tangential direction and wherein the scanning by means of each phased array probe comprises varying the direction and/or position of the ultrasonic beam generated by such phased probe relative the such phased array probe.

16. The method according to claim 15 wherein the scanning by means of the ultrasonic beams comprises varying the direction and/or position of such beam relative to the probe associated with such beam while such beam remains in a plane which comprises an axial axis of the inner pipe.

17. The method according to claim 16 wherein the scanning by means of the ultrasonic beams results from the movement of the ultrasonic probes in the tangential direction of the inner pipe.

18. The method according to claim 1 wherein in step b) at least a full circumferential portion of the weld forming a closed loop is inspected and wherein after step b) in a step d) the at least one probe is moved in an axial direction relative to the inner pipe and wherein after step d) step b) is repeated.

19. The method according to claim 1 wherein step a) comprises mounting a circumferential guide rail around an outer wall of the inner pipe or around an outer wall of the outer pipe, providing a carrier which is attached to the guide rail for travelling, in step b), along the guide rail around the inner pipe, providing an arm fixed to the carrier and which is arranged to extend, in step b), from the carrier via an open end of the inner pipe into the inner pipe wherein the at least one ultrasonic probe is attached to the arm and providing motor drive means for moving the carrier along the guide rail for carrying out step b) of any preceding claim.

20. The method according to claim 19 wherein the guide rail is made to have a shape corresponding to the shape of the inner pipe and/or outer pipe.

21. The method according to claim 1 wherein the at least one probe lays against an inner wall of the inner pipe or is close to the inner wall of the inner pipe.

22. The method according to claim 1 wherein in step b) by means of at least one probe a sectorial scan is carried out and/or by means of at least probe a linear scan is carried out and/or by means of at least one scan a PA-tandem scan is carried out and/or by means of at least two probes a ToFD scan is carried out and/or by means of a Creepwave scan.

23. The apparatus for carrying out a method according to claim 1, said apparatus comprising a circumferential guide rail which is arranged to be mounted around an outer wall of the inner pipe and/or around an outer wall of the outer pipe, a carrier which is attached to the guide rail for travelling, in use, along the guide rail around the inner pipe, an arm attached to the carrier and which is arranged, in use, to extend from the carrier via an open end of the inner pipe into the inner pipe, at least one ultrasonic probe attached to the arm so that, in use the at least one ultrasonic probe is present inside in the inner pipe and motor drive means for moving the carrier along the guide rail for carrying out step b) of any preceding claim.

24. The apparatus according to claim 23 wherein the arm comprises a L-shaped portion wherein a first leg of the L-shaped portion extends in a radial direction of the circumferential guide rail and wherein a second leg of the L-shaped portion extends at least substantially perpendicular to a plane comprising the circumferential guide rail and wherein the at least one probe is attached to the second leg.

25. The apparatus according to any preceding claim 23 wherein the apparatus is arranged for varying and setting the position of the at least one probe relative to the carrier.

26. The apparatus according to claim 25 wherein the apparatus is arranged for varying and setting the position of the at least one probe relative to the carrier wherein said position can be varied in a direction extending at least substantially perpendicular to a plane comprising the circumferential guide rail and in a radial direction relative to the circumferential guide rail.

27. The apparatus according to claim 25 wherein the apparatus is arranged for varying and setting the position of the at least one probe relative to the carrier manually.

28. The apparatus according to claim 23 wherein the at least one probe is a phased array probe.

29. The apparatus according to claim 23 wherein the apparatus is at least provided with a first phased array probe, a second phased array probe and a third phased array probe which are each connected with the carrier and wherein the apparatus is arranged, in use, to position the first probe, the second probe and the third probe inside the inner pipe wherein the first probe is staggered relative to the second probe in a direction extending at least substantially perpendicular to a plane comprising the circumferential guide rail, the third probe is staggered relative the second probe in the direction extending substantially perpendicular to the plane comprising the circumferential guide rail wherein viewed in the direction extending at least substantially perpendicular to the plane comprising the circumferential guide rail the second probe lays between the first probe and the third probe.

30. The apparatus according to claim 23, wherein the apparatus further comprises at least one outer phased array probe which is connected with the carrier and wherein the apparatus is arranged to position the outer phased array probe outside the outer pipe and outside the inner pipe.
